(19) United States
(12) Patent Application Publication
(10) Pub. No.: US 2011/0258082 A1
(43) Pub. Date: Oct. 20, 2011

(54) Application Store for Shared Resource Computing

(75) Inventors: Robert Wilhelm Schmieder, Snoqualmie, WA (US); James S. Duffus, Seattle, WA (US); Clark David Nicholson, Seattle, WA (US); Amit Mital, Kirkland, WA (US)

(73) Assignee: Microsoft Corporation, Redmond, WA (US)

(21) Appl. No.: 12/760,078

(22) Filed: Apr. 14, 2010

(51) Int. Cl. G06Q 99/00; G06Q 20/00; G06Q 50/00; G06F 3/01; G06F 9/455; G06F 9/46; G06Q 30/00; G06F 15/16

(52) U.S. Cl. 705/27.1; 705/40; 705/310; 709/203; 715/738; 718/1; 719/328

(57) ABSTRACT

A server in a Shared Resource Computing (SRC) system runs applications and manages licenses for those applications across multiple sessions and/or user terminals. Plug-ins created by an SRC App Store translate the licensing requirements of various applications into terms that can be monitored and enforced by the SRC App Store. When payments are necessary to comply with the licensing requirements, the SRC App Store manages the payments. The SRC App Store also enforces the licensing requirements by providing feedback regarding enforcement consequences.

### BACKGROUND

The processing and memory capabilities of desktop and laptop computers has increased such that conventional personal computers now have greater computing capability than is needed for many computationally simple tasks such as web browsing, e-mail, and word processing. This excess capability can enable a single computer to support multiple users simultaneously. By attaching several display devices, such as monitors, and several input devices, such as keyboards and mice, multiple users can share a single computer. Using one computer to support multiple users simultaneously is known as Shared Resource Computing (SRC). Schools and libraries in particular may benefit from SRC rather than conventional personal computer systems because computationally simple tasks are likely to predominate (e.g., web browsing rather than 3-D graphics) and the cost per seat of ownership and maintenance is less for an SRC system than an equivalent number of traditional computers. SRC systems have some advantages over networked computer groups in that peripheral devices can often be positioned physically close to the computer which enables highly responsive and reliable connections.

Many computer programs are distributed under a licensing agreement sometimes referred to as an end-user license agreement (EULA). Software licensing agreements may have limitations on how the software is used. For example, use of some software may be limited to only one person or only one computer. Licensing schemes for software provided by a server, such as client access licenses or CALs, exist but implementation of these types of licensing schemes is typically cumbersome and hard to understand for regular computer users. The SRC environment with multiple users but only a single computer can lead to inadvertent license violations particularly with licenses limited to a fixed number of “seats” or users. Given that many SRC systems are likely to be managed by a teacher or other person without formal information technology (IT) training the complex licensing schemes and license-management software used in traditional server environments are unsuitable for the SRC environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject of this disclosure establishes mechanisms through which usage for computer software, or applications, can be monitored and monetized in a uniform and consistent way in a multi-session environment like a Shared Resource Computing (SRC) environment. These mechanisms also provide a unified way to manage application usage rights through concepts and facilities that are easy to understand by users who are not professional computer administrators.

In one implementation, a command to instantiate a Shared Resource Computing Application (SRCApp) may be received from a user terminal in an SRC system. A software plug-in may be created for the SRCApp based on a licensing policy specified by a person or company that makes or sells the application—an SRCApp vendor. Next, the system may determine if a payment specified by licensing policy is accepted. The payment may be represented by tokens or other types of “currency” usable in the SRC environment. If the payment is accepted, an instance of the SRCApp is started and a user interface for the SRCApp is displayed on the user terminal If the payment is not accepted, feedback is provided that indicates some type of enforcement consequences.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an illustrative architecture of an SRC system including a server and multiple terminals.

FIG. 2 is a block diagram showing illustrative communication paths between an SRC App store and multiple SRCApp plug-ins.

FIG. 3 is a schematic diagram showing illustrative plug-ins providing an interface between multiple SRCApps and the SRC App store.

FIG. 4 is a flowchart showing an illustrative method of installing an SRCApp.

FIG. 5 is a flowchart showing an illustrative method of starting an instance of an SRCApp.

FIG. 6 is a schematic diagram of an illustrative architecture of an SRC system showing allocation and storage of tokens.

FIG. 7 is a schematic diagram of an illustrative architecture of multiple SRC systems connected to a network.

FIG. 8 is a block diagram of an illustrative SRC server.

### DETAILED DESCRIPTION

The subject matter relates generally to software licensing management, particularly in the context of shared resource computing. An illustrative shared resource computing (SRC) system may have only one computer (e.g., a device with a processor and a memory) but many user terminals. Other SRC systems may include multiple computers each with one or more terminals. Depending on the software, such as an operating system, running on the computer each of the terminals may be able to run different applications or multiple instances of the same application. Application vendors may desire licensing their software under terms that provide for larger payment if the application is used more and/or if the application is used by a greater number of users rather than simply a flat fee for a single SRC system. Administrators of an SRC system may wish to comply with the licensing requirements (i.e., pay the appropriate amount) in a way that is simple and consistent across multiple different application vendors.

### Illustrative Shared Resource Computing (SRC) System

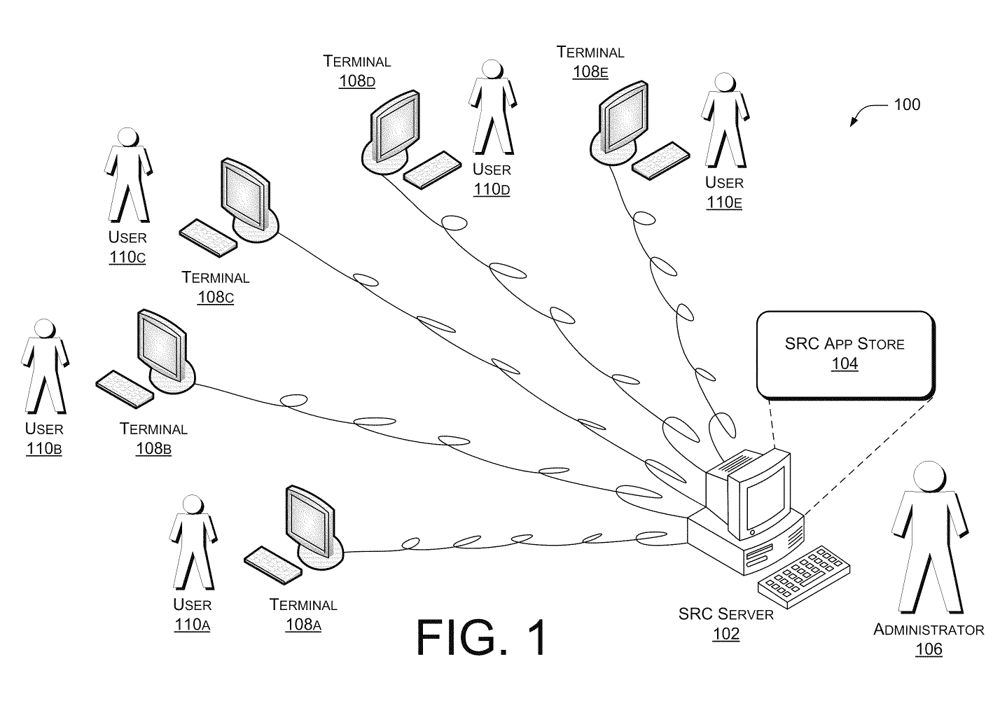

FIG. 1 shows an architecture 100 of an SRC system. The SCR system includes an SRC server 102, which may be a conventional desktop or laptop computer. Other examples of SRC servers include conventional Web servers, set-top boxes, gaming consoles, cellphones, personal digital assistants, and the like. Although termed a “server,” the SRC server 102 is not necessarily connected to a network. The SRC server 102 may include an SRC App Store 104 for managing software applications on the SRC server 102 and for enforcing the respective licensing requirements of those software applications. In other implementations, the SRC App store 104 may be located someplace other than the SRC server 102 such as a remote network server. The SRC App Store 104 will be discussed in greater detail below. An administrator 106 may manage the SRC system from the SRC server 102 and/or use the SRC server 102 as a conventional computer. If an SRC system is deployed in a classroom setting, the administrator 106 may be a teacher rather than an IT technician. Applications in the home setting may include a single computing device, for example a conventional desktop computer, that functions as the SRC server with a multitude of other devices such as laptop terminals, terminals with a monitor and keyboard similar to a desktop computer, a set-top box coupled to a television set, etc. as the terminals. Similarly, in a business setting a company may have a single computing device that functions as the SRC server for a group of employees who each have a terminal at their respective workstations. Depending on the size of the company and the number of employees, there may be multiple SRC servers networked together forming an intranet or other local area network.

The SRC system also includes several user terminals 108. Five user terminals 108A, 108B, 108C, 108D, and 108E are shown in FIG. 1. However, a greater or lesser number of terminals 108 may be connected to the SRC server 102. The terminals 108 may comprise input and output devices without separate processors or memory. In other implementations, the terminals 108 may be thin clients with limited processors and/or memory. Each user terminal 108 provides input and output devices (e.g., a keyboard and a monitor) for a user 110. Continuing with the classroom example, the users 110A, 110B, 110C, 110D, and 110E may be students.

Applications available to users 110 of the terminals 108 in the SRC system are referred to as SRCApps. The term SRCApp encompass more than simply software applications run from a local computer. SRCApps may include programs, virtual machines containing one or more applications configured to run within the virtual machines, remote desktop sessions with a remote computing device, and the like. The SRCApps may group together various resources in any fashion as designated by the creator of an SRCApp. For example, a virtual machine may be targeted for a specific scenario such as a chemistry class and include within the virtual machine programs for simulating experiments and making entries into a virtual lab notebook. In some implementations, the SRCApp may be a read-only virtual machine image. In other implementations, the virtual machines may be cloned from a central image assigned to a user 110 and used in a read-write fashion. The SRC App store 104 may treat all the resources within a virtual machine or a remote session as a single entity both from license management and user interaction perspectives.

### Illustrative SRC App Store

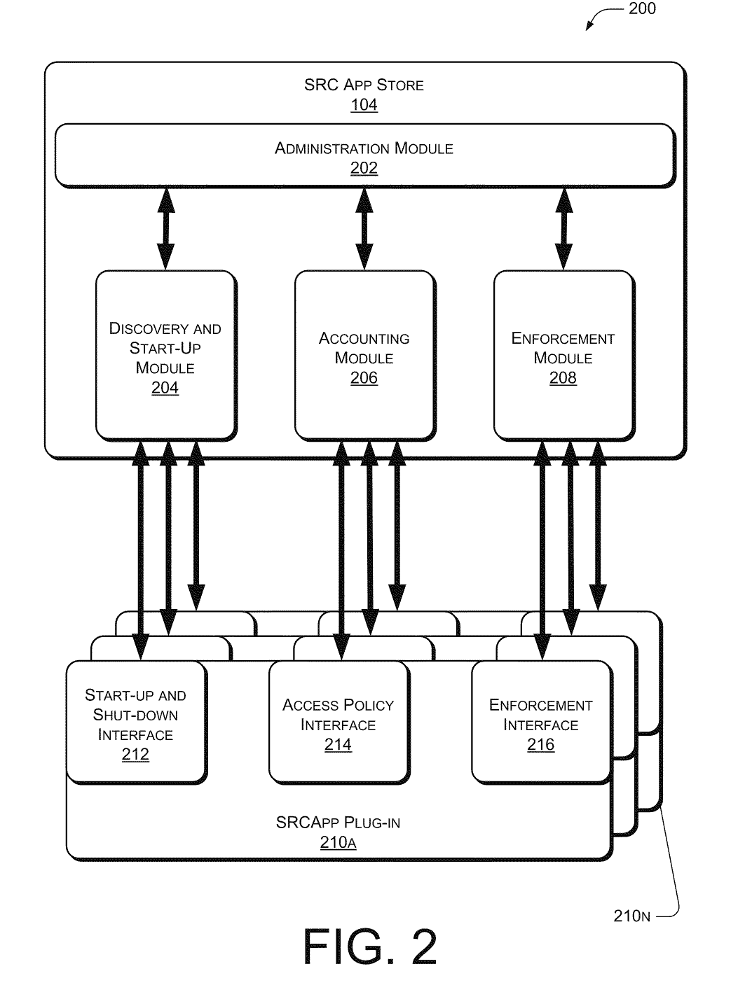

FIG. 2 shows a block diagram 200 of the SRC App Store 104. The SRC App Store 104 includes several modules for managing applications and enforcing licensing requirements. These modules comprise an Administration Module 202, a Discovery and Start-up Module 204, an Accounting Module 206, and an Enforcement Module 208. The SRC App Store 104 may be extended by adding other optional modules such as a Network Module that may become available once the SRC App Store 104 detects an Internet connection.

The SRC App Store 104 through its various modules communicates with SRCApp Plug-ins 210. Each SRCApp being managed by the SRC App Store 104 has a respective SRCApp Plug-in 210A-210N which corresponds to the SRCApp. The SRCApp Plug-in 210 comprises several interfaces such as a Start-up and Shut-down Interface 212, an Access Policy Interface 214, and an Enforcement Interface 216. The SRCApp Plug-in 210 may be an application programming interface (API) that translates disparate licensing requirements from various SRCApps into standardized licensing/enforcement information for the SRC App Store 104. The licensing requirements can be specified by the SRCApp vendor by selecting from preset options that are interpreted by the SRC App Store 104 or for a license that differs from the preset options the SRCApp vendor can write a custom XML file that describes the license policy. The SRCApp vendor may also modify an existing XML file to customize specific licensing parameters. For example, the preset options may include such licensing requirements as payment upon initial instillation, payment upon launch, payment per user or seat, payment per minute or hour used, and the like. More complicated licensing requirements are essentially unlimited, but could include payment requirements such as an initial fee for installation and further fees for an amount of data accessed coupled with options to pay higher or lower fees for data usage depending on an amount of advertising that is presented to the end users. Implementation of the relatively more complex licensing requirements may be achieved by executable code such as code implemented in dynamic link libraries (DLLs) or other libraries that implement a set of mechanisms specified by the SRCApp vendor.

The Administration Module 202 is configured to expose installed SRCApps to the administrator 106 of the SRC environment. The Administration Module 202 is primarily responsible for creating a user interface (UI) and mediating communication between the other modules. The UI created by the Administration Module 202 may include an SRCApp charge history including optional per terminal and/or per user statistics. The administration module 202 may also include the current credit balance as well as money, which may be represented by tokens, currently in use by an SRCApp, terminal 108, or user 110, as well as provide token use information to the administrator 106. The Administration Module 202 may be used to add more money to the SRC environment and place tokens in a token storage. The Administration Module 202 can also provide windows management instrumentation (WMI)/component object model (COM) interfaces for add-on monitoring tools or extensions. SRCApps running on the SRC system may be registered through interfaces or UIs exposed by the Administration Module 202.

The Discovery and Start-up Module 204 allows the SRC system to treat the SRCApps in a uniform way regardless of whether a SRCApp is a program, a collection of programs, one or more virtual machines, or a remote terminal server sessions. The Discovery and Start-up Module 204 is configured to show available SRCApps to a user 110 through UI constructs presented on a terminal 108 in a unified UI. Once an SRCApp is installed and registered it will become available to the user 110. The UI constructs can be specific to the SRC Server 102 or can be integrated into a standard operating system (OS) shell or user interface such as by inclusion in a “start” menu.

The Discovery and Start-up Module 204 may be invoked through a custom console or an OS entry point with parameters that describe the SRCApp, the terminal 108 and/or the user 110 that is launching the SRCApp. The Discovery and Start-up Module 204 may also create a plug-in 210 for the SRCApp and pass to the plug-in 210 the parameters that were provided through the OS entry point. The Discovery and Start-up Module 204 is in communication with the Start-up and Shut-down Interface 212 of the SRCApp Plug-in 210. The Start-up and Shut-down Interface 212 is configured launch and/or terminate SRCApps in response to commands from the user 110 or the administrator 106. The Start-up and Shut-down Interface 212 facilitates communication between the SRC App Store 104 and the SRCApp Plug-in 210 by, for example, the status of the SRCApp and informs the Discovery and Startup Module 204 when an instance of the SRCApp is no longer active on the user terminal 108.

In some implementations, the Discovery and Start-up Module 204 may detect the launch of legacy software applications that are not SRC App Store 104 aware. For example, a legacy application may be launched through invoking the executable without using a start menu entry point for a SRCApp. The Discovery and Start-up Module 204 can monitor the executables that are running and take an action if a launch of a legacy application is detected. In other implementations, the Administration Module 202 may enforce application startup in which case the SRCApp itself is not aware of the enforcement mechanism.

The Discovery and Start-up Module 204 may also implement policies established by the Administration Module 202. For example, launch of specific SRCApps could be restricted to certain times of the day or specific SRCApps on a terminal could be launched or terminated remotely 108 by the Administration Module 202. In the classroom example, a teacher may wish to control which applications are open on the terminals 108 during a class.

The Accounting Module 206 is primarily used to manage the availability of credits or tokens for a particular SRC environment. Tokens, credits, and the like are representative of monetary payments and will be discussed in greater detail below. The Accounting Module 206 may be configured to process token additions to a token storage, process token withdrawals from the token storage, and allocate tokens between SRCApps. Tokens may be withdrawn from the token storage in a temporary or permanent fashion based on the particular monetization model specified by a license policy of an SRCApp. The Accounting Module 206 of the SRC App Store 104 may reallocate tokens between different SRCApps. For example, imagine that tokens allocated to one SRCApp are no longer necessary because a student has finished using the application but those tokens are needed in order to launch a different SRCApp.

The Accounting Module 206 communicates with the Access Policy Interface 214 which is configured to apply a licensing policy specified by the SRCApp vendor and request a token charge. By using the Access Policy Interface 214, the SRCApp Plug-in 210 may have the ability to “charge” tokens based on usage. The number of tokens charged and the types of uses for which tokens are charged is specified by the SRC App vendor. For example, an SRCApp could cost $50 to install and $3 for each simultaneously active instance of the SRCApp. If one token is valued at $1 then 53 tokens would be required to install and run the SRCApp for one user. If the administrator 106 purchased tokens in another currency, then a currency exchange rate could be used to determine how many tokens are necessary in a native currency of the administrator 106. Regardless of the payment model or licensing terms specified by the SRCApp vendor, a unified payment system is achieved through the information exchange between the Accounting Module 206 and the Access Policy Interface 214. The multitude of possible licensing requirements is presented to the administrator 106 simply as a number of tokens for a given activity. Thus, the administrator 106 does not need to be concerned with making credit card payments, entering product activation codes, contacting the IT department to obtain another seat license, or other various ways for paying for license rights to use an application.

The Enforcement Module 208 is used to enforce consequences when a particular SRCApp is used in a manner that violates its licensing terms. The SRC App Store 104 may detect a violation and then the Enforcement Module 208 may be configured to notify a plug-in that a usage violation exists, and/or implement an enforcement response. Generally violations of licensing terms exist when a fee for certain software functionality (e.g., installing the software, launching the software, running simultaneously for multiple users, and the like) has not been paid either with tokens or by some other means. When the licensing terms described by an SRCApp Plug-in 210 are violated, the Enforcement Module 208 may communicate with the Enforcement Interface 216 of the SRCApp Plug-in 210. The Enforcement Interface 216 is configured to provide feedback to the user 110 and/or the administrator 106 when a usage violation exists. The SRCApp Plug-in 210 may enforce licensing terms by displaying an appropriate notification message to the user 110 of the terminal 108, suspending operation of the SRCApp, and/or terminating one or more instances of the SRCApp. The notification message may be displayed to the user 110 and/or the administrator 106 and the notification message may be similar to an error message or pop-up window indicating that additional tokens are needed or else the SRCApp will terminate, lose functionality, initiate an automatic purchase or transfer of tokens, or the like. An event may be logged in an administration console instead of or in addition to the notification message.

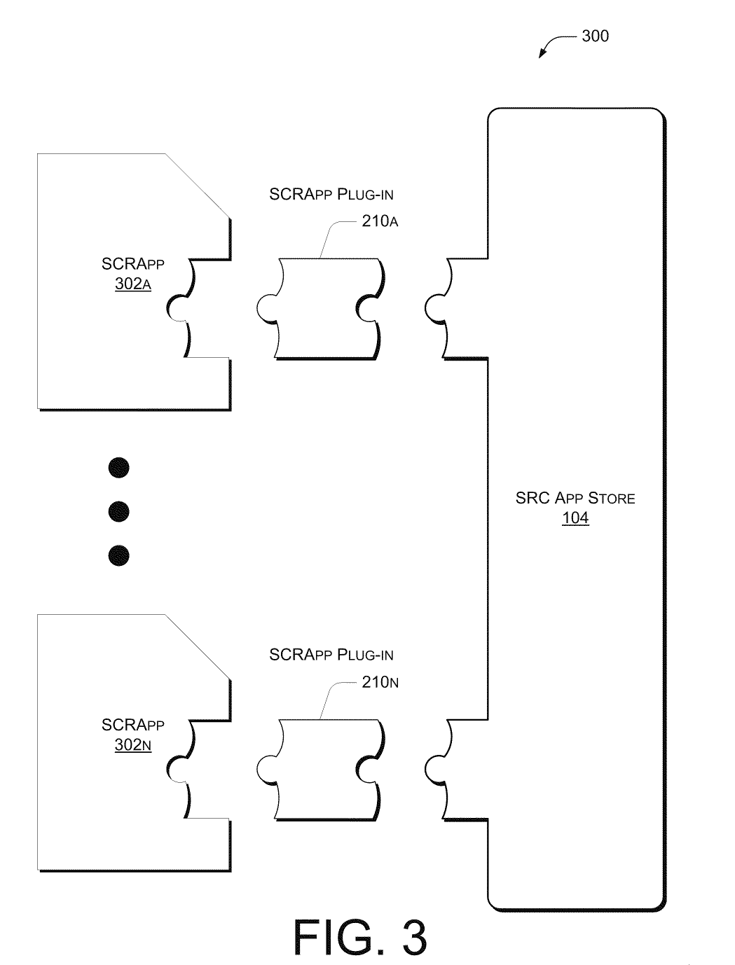

FIG. 3 shows a schematic diagram 300 of a plurality SRCApps 302A-302N interfacing with the SRC App Store 104 via a corresponding plurality of SRCApp Plug-ins 210A-210N. The SRCApp Plug-ins 210A-210N in FIG. 3 may correspond to the SRCApp Plug-ins 210A-210N in FIG. 2. As discussed above, an SRCApp Plug-in 210 is created for each SRCApp 302 by the SCR App Store 104. Each respective SRCApp Plug-in 210A-210N may translate the various licensing requirements of the SRCApp 302 into a format that can be understood by a unified application programming interface (API) of the SRC App Store 104. The SRCApp Plug-in 210 may be a component object model (COM) object, an ActiveX® object, or a static extensible markup language (XML) file. When the SRCApp Plug-in 210 is a static XML file, the XML file may simply describe the licensing and enforcement model for a particular SRCApp. A simple XML based registration mechanism may be utilized for many SRCApps, particularly SRCApps that that have relatively straightforward licensing requirements. The XML, SRCApp Plug-ins 210 may be used for legacy software applications that are not SRC App Store 104 aware. For legacy software applications, the Enforcement Interface 216 may take the form of an XML file that simply provides the proper info so the SCRApp Store 104 itself can take the appropriate action. For example, the SRCApp Store 104 may apply a default enforcement action (e.g., warning the administrator but allowing the application to run) for all legacy applications that do not otherwise provide for enforcement in an SRC environment.

In some implementations, applications will be installed and run on the SRC system that have not been modified to meet the definition of a SRCApp 302. For example, there may be an application that does not have a corresponding SRCApp Plug-in 210 for the SRC App Store 104. To handle these legacy applications, the SRC App Store 104 may query standard operating system APIs to determine which applications are currently installed. The currently installed applications that lack a plug-in will then be registered with a default SRCApp plug-in that provides default policies and interfaces. The SRC App Store 104 may use those default policies to determine if starting an instance of the legacy application complies with the default licensing policy. For example, the default access policy may be based on concurrent instances. The SRC App Store 104 may provide a user interface for the administrator 106 to specify a number of concurrent licenses owned for the legacy application. The default plug-in will then monitor the number of concurrent instances of the legacy application that are running on the SRC system at a given time. The default legacy application enforcement policy may generate notification or warning messages whenever the number of concurrent running instances exceeds the number of concurrent licenses for the legacy application. Alternatively, the default legacy application enforcement policy might be set to stop additional instances from running once the licensed limit has been reached to ensure that the number of running instances does not exceed the number of concurrent licenses. The enforcement policy (e.g., warning message or preventing additional instances of the application from starting) may be settable by the administrator 106.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that can be implemented in hardware, software, or a combination of hardware and software. For discussion purposes, the processes are described with reference to the system shown in FIGS. 1-3. However, the processes may be performed using different architectures and devices.

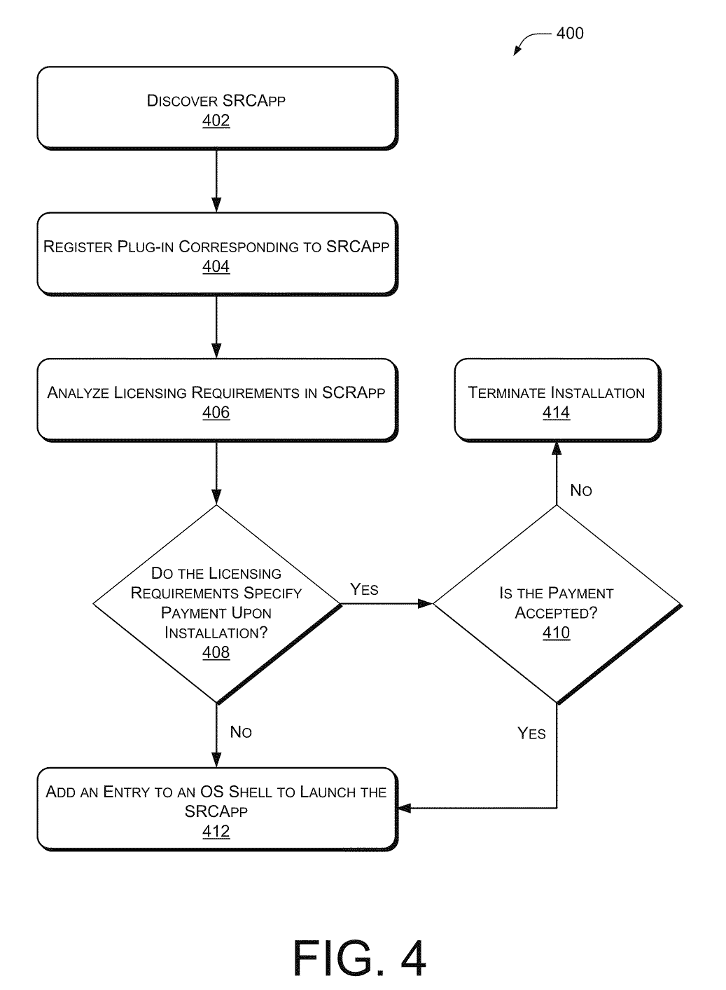

FIG. 4 illustrates a flowchart of a process 400 installing an SRCApp. At block 402, the SRC App Store 104 discovers an SRCApp when the SRCApp is initially installed on a SRC server 102 in an SRC environment. The SRCApp may be installed from computer-readable media such as a CD-ROM or flash drive, downloaded from a network such as the Internet, or the like. The administrator 106 may install most of the SRCApps. However, it is equally possible for a user 110 to install an SRCApp. In some implementations, such as when the administrator 106 is a teacher and the users 110A-110E are students, the SRC App Store 104 may require administrator approval before allowing a user 110 to install a new SRCApp.

At block 404, an SRCApp Plug-in 210 that corresponds to the SRCApp is registered with the SRC App Store 104. The SRCApp Plug-in 210 may be registered when a SRCApp is launched. Registering the SRCApp Plug-in 210 allows the SRC App Store 104 to expose the existence of the SRCApp both to the users 110A-110E and the administrator 106. For example, registering the SRCApp Plug-in 210 may comprise making an entry point in the shell of the operating system of the SRC server 102 and assigning a global unique identifier (GUID) to the SRCApp Plug-in 210. Registration may be implemented by adding an entry in a well-known SRCApp Store 104 registry key or configuration file. The entry may describe a path to a DLL that is configured to implement SRCApp Plug-ins 210, the entry may be a class identifier (CLSID) for a component object model (COM) object that implements the SRCApp Plug-ins 210, or the like. Registration provides enough information for the Discovery and Startup Module 204 to be able to launch the SRCApp. The start menu entry may point to the Discovery and Startup Module 204. The Discovery and Startup Module 204 can make sure that non-executable SRCApps (e.g., virtual machines) may be launched in a seamless and unified fashion like any other program.

At block 406, licensing requirements included in the SRCApp are analyzed by the SRC App Store 104. As discussed above, licensing requirements freely specified by the SRCApp vendor are translated by the SRC App Store 104 into standardized licensing and enforcement information. The SRCApp Plug-in 210 works in conjunction with the SRCApp itself to provide this licensing and enforcement information to the SRC App Store 104.

At block 408, it is determined if the licensing requirements specify charges for initial installation of the SRCApp. As discussed above, the licensing requirements and monetization model are made at the discretion of the SRC App vendor. Some vendors may design the license requirements such that payment is necessary upon installation whereas other vendors may opt for a different monetization model. When there is a charge for initial installation, process 400 proceeds along the “yes” branch to block 410. When there is no charge for initial installation, process 400 proceeds along the “no” branch to block 412.

At block 410, when charges for initial installation of the SRCApp are specified, it is determined if a payment is accepted. This determination may be performed by the Accounting Module 206 in conjunction with the Access Policy Interface 214. The payment may be rejected if sufficient tokens are not available or if available tokens are otherwise allocated. When the payment is accepted, process 400 proceeds along the “yes” branch to block 412. When the payment is not accepted, process 400 proceeds along the “no” branch to block 414 and terminates installation of the SRCApp.

At block 414, an entry is added to a shell of an OS of the SRC server 102, the entry configured to launch an instance of the SRCApp when activated by an administrator 106 or a user 110. The entry may be placed in a “start” menu or other part of a UI along with entries for any other programs that are available on the SRC server 102. If the SRCApp is a virtual machine image, the entry may be a shortcut with enough meta-data so that the SRCApp Plug-in 210 can retrieve the correct virtual machine image for a particular user (e.g., a one of the users 110A-110E in FIG. 1). By including entries for SRCApps and other applications in a unified UI, the SRC App Store 104 provides a transparent experience for the users 110 such that the users 110 do not need to recognize or directly interact with the SRC App Store 104 in order to access the functionality of the SRCApps.

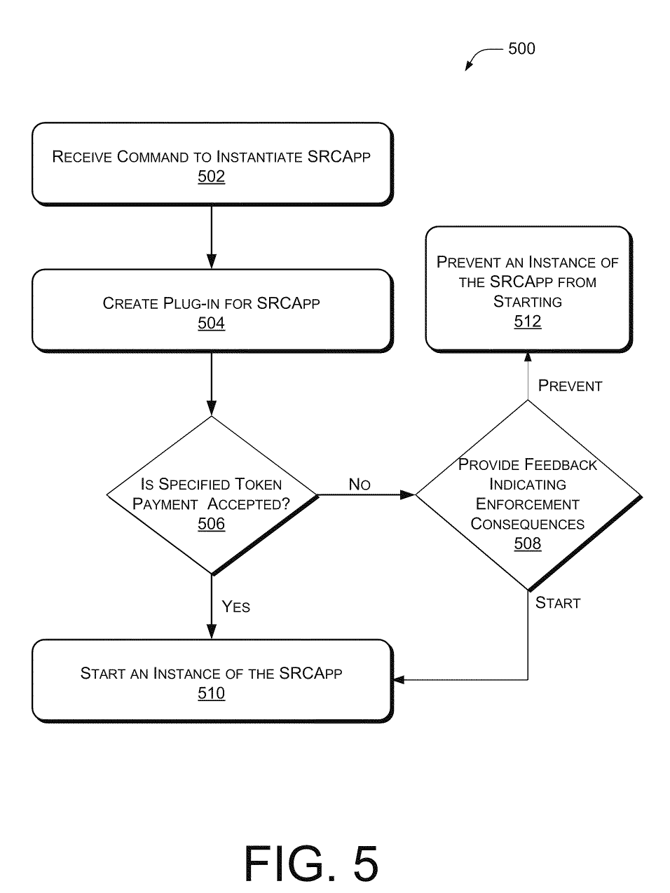

FIG. 5 illustrates a flowchart of a process 500 for launching an instance of an SRCApp. At block 502, a command to instantiate an SRCApp is received from a user terminal 108. The command may invoke the Discovery and Start-up Module 204 through a custom console or an OS entry point with parameters that describe the SRCApp, the terminal 108 and/or the user 110 that is launching the SRCApp.

At block 504, a plug-in for the SRCApp is created based on registration information specified by the SRCApp vendor. The SRCApp Plug-in 210 may be created by the Discovery and Start-up Module 204 which will pass the parameters provided through the entry point to the SRCApp Plug-in 210.

At block 506, it is determined if a token payment specified by the licensing policy is accepted. The SRCApp Plug-in 210 may determine if the SRCApp is authorized to run by requesting a “token charge” to the Accounting Module 206. A number of tokens that are charged may vary from application to application based on the licensing model and the actual price as set by the SRCApp vendor. When the token payment is not accepted, the process 500 proceeds along the “no” branch to block 508.

At block 508, feedback indicating enforcement consequences is provided. The enforcement consequences may include preventing the instance of the SRCApp from starting, notifying the administrator 106 that the SRCApp cannot start, notifying the user 110 that the SRCApp cannot start, starting an instance of the SRCApp with a warning message, or starting an instance of the SRCApp with limited functionality. It the enforcement consequences allow an instance of the SRCApp to start, process 500 may proceed from block 408 to block 510 and start an instance of the SRCApp. Alternatively, if the enforcement consequence prevents the SRCApp starting, process 500 may proceed to block 512 in which an instance of the SRCApp is prevented from starting. The SRCApp may be notified of the licensing violation through the Enforcement Interface 216 of the SRCApp Plug-in 210. The Enforcement Module 208 may notify the administrator 106 through targeted tools such as message boxes or tray notifications that more tokens or credits are needed in order for the SRCApp to be used in compliance with the corresponding licensing model.

Returning to block 506, when the token payment is accepted, process 500 proceeds from block 506 along the “yes” branch to block 510 and starts an instance of the SRCApp and displays a user interface for the SRCApp on the user terminal 108. Once the payment is accepted by the Accounting Module 206 the SRCApp Plug-in 210 can launch the SRCApp. For example, the process of “launching” the SRCApp can include retrieving a virtual machine image from a store, starting the virtual machine, and connecting a remote desktop protocol (RDP) client to that virtual machine. The user 110 may interact with one or more applications that are pre-configured on that virtual machine and through the RDP client.

### Illustrative Token Management

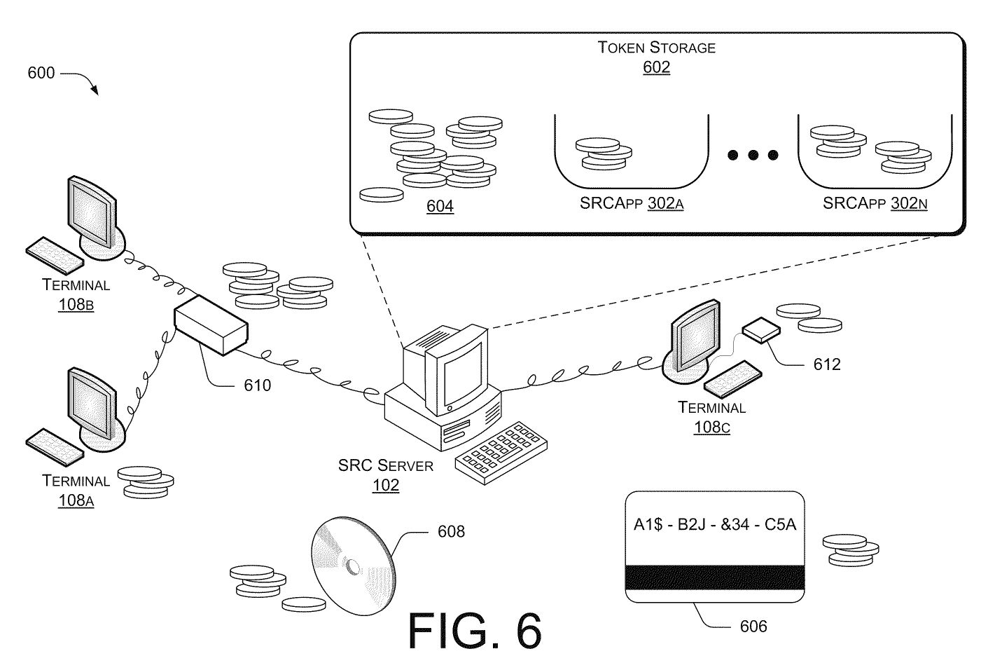

FIG. 6 shows an architecture 600 of an SRC system for allocating and managing tokens. The SRC server 102 and the terminals 108A-108C may be the same as shown in FIG. 1. Only three terminals 108A-108C are shown, but a greater or lesser number of terminals may be connected to the SRC server 102. The SRC server 102 may include a token storage 602 for storing and allocating tokens across SRCApps. As discussed above, tokens are a representation of currency or money and may include any type of monetary representation such as credits, points, and the like. The Accounting Module 206 of the SRC App Store 104 may function to add, withdraw, or reallocate tokens within the token storage 602.

The token storage 602 includes a shared pool of tokens 604 that may be allocated by the administrator 106 or in some implementations also by the users 110. Tokens may be associated with a particular SRCApp 302A-302N and allocated to a specific bin or account associated with the respective SRCApp 302A-302N. The tokens may also be allocated to a specific user or administrator. In some implementations, the tokens may be additionally restricted for usage only during a specified time period. After the time period has passed the tokens may be eligible for “recharge” which may renew the token functionality for a further time. The costs to “recharge” a token may be less than the initial cost to purchase the token.

The tokens may be temporarily or permanently allocated to an SRCApp. In some implementations, the allocation may result in the SRCApp Plug-in 210 subtracting tokens from the shared pool of tokens 604. For example, if an SRCApp requires a one-time charge per SRC server 102, a number of tokens may be permanently allocated to the SRCApp. Other payment models may include a per-instance model in which tokens are charged when an instance of the SRCApp is launched and the tokens are returned to the shared pool of tokens 604 when the instance of the SRCApp is closed. The SRC App Store 104 temporarily holds the tokens while the instance of the SRCApp is active. This “holding” may be applied when the allocated tokens are sufficient only to authorize a limited number of simultaneous users. For example, each terminal 108 or user 110 with an open instance of the SRCApp may temporarily remove a number of tokens from the token pool 604 while the SRCApp is open on that terminal 108.

Tokens may be added to the token storage 602 in a variety of ways. One illustrative way of adding tokens to the token storage 602 is by manually entering a code provided on a card 606 analogous to a prepaid “phone-card.” The code may be a long cryptographic string that specifies a number of tokens. Other ways of adding tokens include loading computer-readable media (e.g. CD-ROM disks, SD cards, flash drives, etc.) into the SRC server 102. The media may carry a cryptographic certificate that is interpreted by the SRC App Store 104 as representing a number of tokens. SRCApps themselves may also come with tokens such as, for example, tokens that may be used with related SRCApps or other applications from the same vendor. Hardware devices may also come preconfigured with a certain number of tokens. For example, a terminal 108A, and/or an SRC hub 610 for connecting terminals 108A, 108B to the SRC server 102 may contain a number of tokens. In some implementations, the tokens in the SRC hub 610 may be available only to the terminals 108A, 108B attached to the SRC hub 610 or, in other implementations, the tokens may be available throughout the entire SRC system. In addition to an SRC hub 610, other hardware devices 612 attached to the SRC server 102 or a user terminal 108C may also supply tokens. These other hardware devices 612 may include a dongle, and input device, and output device, or the like. The Accounting Module 206 may automatically scan the SRC system to identify which hardware is associated with tokens, a number of tokens associated with each hardware device, and how those tokens may be used. In some implementations, the Accounting Module 206 may also allocate a number of tokens that may be used by a single terminal and this allocation may limit the number of applications likely run simultaneously on the single terminal

The methods described above may all be used to add tokens in an off-line mode. It is also possible to add tokens by using an online SRC centralized Internet store. The administrator 106 may add tokens from the Internet store by using a credit card or other type of electronic commerce payment. In some implementations, users 110 may also add tokens from Internet store. Administrator 106 approval may be required a user 110 to add tokens especially if adding tokens will incur an additional charge. In other implementations, tokens may be added automatically by the SRC App Store 104 when more tokens are needed.

Tokens in the SRC system may be universally available or may be limited to use only by specific hardware devices (e.g., user terminals 108) or only for specific SRCApps. For example a hardware device 612 such as a dongle attached to a terminal 108C may provide tokens that are only usable by that terminal 108C. Additionally, the hardware device 612 and/or one of the user terminals 108 may come preloaded with tokens that are allocated to a specific SRCApp. Alternatively, an SRC vendor may sell cards 606 or media 608 that include tokens which may only be used for SRCApps provided by the specific SRC vendor. This payment model enables the appropriate SRC vendor to receive payment in an off-line model where the SRC vendor cannot directly track SRCApp usage. The SRC App Store 104 may be configured to direct charges to limited-use tokens before charging general-use tokens from the token storage 602. For example, tokens required by a terminal 108A may be provided first from an associated SRC hub 610 and then if necessary provided from the pool of tokens 604 in the token storage 602. Similarly, tokens limited to use for a specific SRCApp or family of applications from a specific SRC vendor may be charged first when the specific SRCApp requires tokens and general-use tokens may be charged only when the specific-use tokens are depleted. Generally, the SRC App Store 104 is configured to use the most restrictive tokens first and use the most widely available tokens last.

Management of tokens in an SRC environment may be performed automatically, manually, or both. The Accounting Module 206 may create a user interface for the administrator 106 to manually manage the tokens. The user interface may include representations of tokens within the SRC environment and show where tokens are allocated in terms of both SRCApps and hardware devices. The user interface may allow the administrator 106 to move tokens between the shared pool of tokens 604 and various SRCApps 302A-302N. For example, if an SRCApp has a “usage time” policy where a number of tokens is required per time period (e.g. one token/minute), tokens allocated to that SRCApp will decrease over time and more tokens may need to be added in order to continue using the SRCApp. Accordingly, the user interface may receive input from the administrator 106 and re-allocate tokens from a first SRCApp to a second SRCApp in response to the input.

Other monetization models may require a one-time charge per a user or for a certain number of users. For example, licensing terms may allow an instance of an SRCApp to run on up to three terminals 108 simultaneously for a set number of tokens. In this example, if a fourth terminal attempts to initiate an instance of the SRCApp enforcement consequences may be triggered. The administrator 106 may be able to allocate additional tokens either to the SRCApp itself or to the terminal 108 that intends to initiate the fourth instance of the SRCApp so that the fourth instance of the SRCApp can be initiated. Alternatively, tokens may be reallocated from one user terminal 108A to another user terminal 108C. For example if a user 110 of one of the terminals 108A with an open instance of the SRCApp is no longer using that SRCApp the administrator 106 may terminate that instance of the SRCApp and transfer tokens from that terminal 108A to another terminal 108C that is waiting to use the SRCApp. This could occur, for example, when a student/user 110 leaves his or her terminal 108 without shutting down the SRCApp.

In some implementations, the Administration Module 202 may also function to generate a user interface that includes a current credit balance as well as any tokens that are currently in use by an SRCApp, terminal 108, or user 110. The Administration Module 202 may provide a tool for initiating token upload to the token storage 602.

An online SRC centralized Internet store from which tokens may be purchased can be maintained on the network server(s) 710 the remote computing device(s) 708, or another computing device in communication with the network 702.

### Illustrative Networked Systems

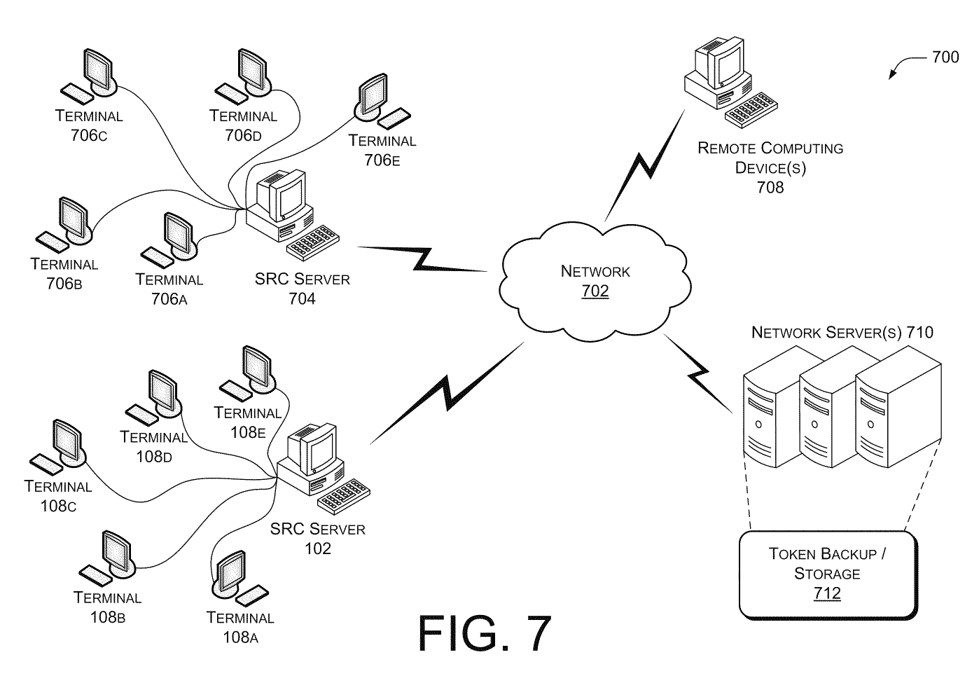

FIG. 7 shows an architecture 700 of multiple SRC systems connected to a network 702. An SRC system such as discussed above with respect to FIGS. 1-6 may function without connection to a network or multiple SRC systems may be connected together in a local area network, wide-area network, or the like. Additionally, SRC systems may be connected to a network such as the Internet and such connectivity may allow for additional functionality.

In this illustrative architecture 700, a first SRC system with an SRC server 102 and terminals 108A-108E and a second SRC system with another SRC server 704 and terminals 706A-706E are connected to a network 702. Returning to the example of an academic setting, each classroom may have an SRC system and there may be a network within the school connecting each of the SRC systems in each of the classrooms. The network within the school may be self-contained or alternatively it may be connected to the Internet or another external network. In some implementations, tokens may be shared between multiple SRC systems. For instance, if a teacher changes classrooms during the day he or she may move tokens to a different SRC system either by moving a hardware device and/or smart card that is associated with tokens or by accessing a user interface provided by the SRC App Store 104 that presents token information of multiple SRC systems. The SRC Server 102 may also be configured with more than one SRC App Store 104 and the appropriate SRC App Store 104 may be loaded when the teacher logs on based on the log on credentials so that different teachers have access to different SRC App Stores 104 on the same SRC Server 102.

The network 702 may also be connected to remote computing device(s) 708 configured to provide SRCApps through a remote session, remote desktop, terminal session, or the like. The remote computing devices 708 may be another SRC server. For example, an SRC server 704 associated with a first SRC system could function as a remote computing device for another SRC system and its respective server 102 and terminals 108A-108E.

Network server(s) 710 may provide a Token Backup/Storage 712. The number of tokens as well as their allocations per SRCApp could be backed up on a centralized online service so in case of hardware failure the SRC Server 102, 704 administrator 106 or owner can restore the token information to the SRC App Store 104. The network server(s) 710 may be in constant communication with the SRC server 102, 704 via the network 702, or alternatively the SRC server 102, 704 may periodically connect to the network server(s) 710 to backup the token information. SRCApps and user data may also be stored or backed up on the Token Backup/Storage 712, and thus, keep a record of the existing usage rights allotted to an SRC system. The network server(s) 710 may also back up the SRCApp Plug-ins 210 thus providing a backup of the licensing policies. In some implementations, such as implementations with a constant network connection, token information and even the entire SRC App store 104 may be maintained on the network server(s) 710 instead of or in addition to the SRC server 102, 704.

### Illustrative Computing Device

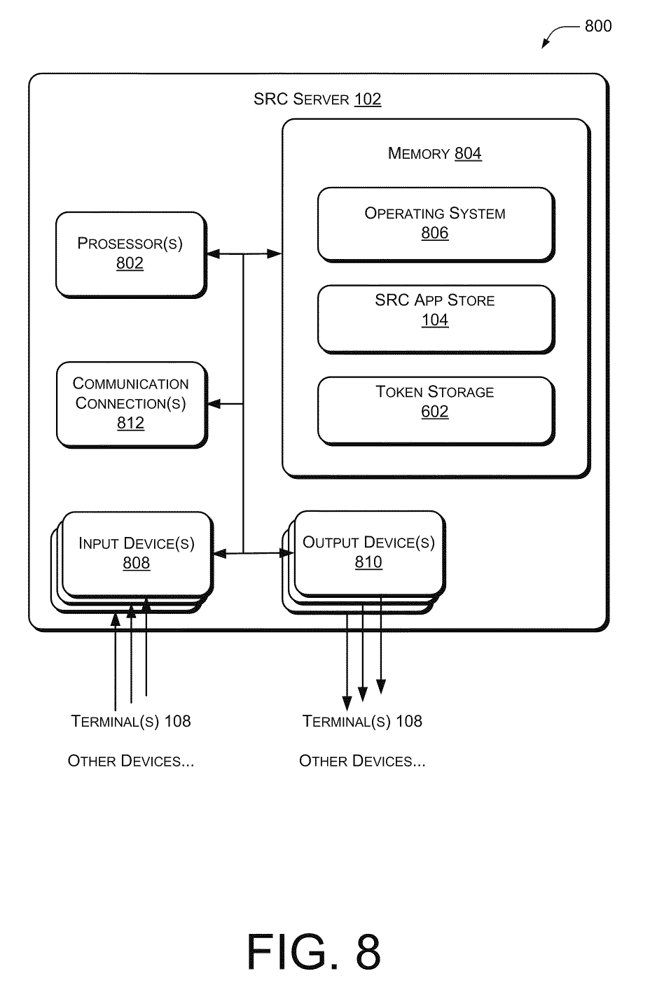

FIG. 8 is a block diagram 800 showing an illustrative SRC server 102 for managing an SRC system. The SRC server 102 may be configured as any suitable system capable of delivering SRCApp functionality to user terminals 108. In one illustrative configuration, the SRC server 102 comprises one or more processor(s) 802 and memory 804. The processor(s) 802 may be implemented as appropriate in hardware, software, firmware, or combinations thereof Software or firmware implementations of the processor(s) 802 may include computer- or machine-executable instructions written in any suitable programming language to perform the various functions described.

For example, the SRC server 102 illustrates an architecture of these components residing on one system. Alternatively, these components may reside in multiple other locations, servers, or systems. For instance, all of the components may exist on a remote server accessed through a network 702. Furthermore, two or more of the illustrated components may combine to form a single component at a single location. The illustrated components may also reside in an SRC server 102 without a connection to a network, such as a stand-alone desktop or laptop computing device.

Memory 804 may store programs of instructions that are loadable and executable on the processor(s) of 802, as well as data generated during the execution of these programs. Depending on the configuration and type of SRC server 102, memory 804 may be volatile (such as RAM) and/or non-volatile (such as ROM, flash memory, etc.). The SRC server 102 may also include additional removable storage and/or non-removable storage including, but not limited to, magnetic storage, optical disks, and/or tape storage. The disk drives and their associated computer-readable media may provide non-volatile storage of computer readable instructions, data structures, program modules, and other data.

Computer-readable storage media includes volatile and nonvolatile, removable and non-removable media implemented in any method or technology for storage of information such as computer-readable instructions, data structures, program modules or other data. Memory 804 is an example of computer-readable storage media. Additional types of computer-readable storage media that may be present include, but are not limited to, tangible and non-transitory memory such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by the SRC server 102.

Turning to the contents of the memory 804 in more detail, the memory 804 may include an operating system 806, the SRC App Store 104, and the token storage 602. As discussed above, the SRC App Store 104 may comprise multiple modules. The token storage 602 may include a shared pool of tokens 604 and/or tokens allocated to specific SRCApps.

The SRC server 102 may also include input device(s) 808 such as a keyboard, mouse, pen, voice input device, touch input device, stylus, and the like, and output device(s) 810 such as a display, monitor, speakers, printer, etc. All these devices are well known in the art and need not be discussed at length. The input and output devices coupled to the SRC server 102 in the SRC environment may include the user terminals 108A-108E. The SRC server 102 may also include other input or output devices which are not part of the user terminals 108A-108E.

The SRC server 102 may also contain a communication connection(s) 812 that allows the SRC server 102 to communicate with other devices such as network server(s) 704 and/or remote computing device(s) 712. Communication connection(s) 812 is an example of a mechanism for receiving and sending communication media. Communication media typically embodies computer readable instructions, data structures, and program modules. By way of example, and not limitation, communication media includes wired media such as a wired network or direct-wired connection, and wireless media such as acoustic, RF, infrared and other wireless media.

The subject matter described above can be implemented in hardware, software, or in both hardware and software. Although implementations of an SRC App Store 104 have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of controlling access to resources. For example, the methodological acts need not be performed in the order or combinations described herein, and may be performed in any combination of one or more acts.

1. A system comprising:
a processor;
a memory coupled to the processor;
an administration module stored in the memory and executable on the processor, the administration module configured to expose installed Shared Resource Computing Applications (SRCApps) to an administrator of a Shared Resource Computing (SRC) environment;
a discovery and start-up module stored in the memory and executable on the processor, the discovery and start up module configured to show available SRCApps to a user of a user terminal in the SRC environment in a unified user interface and create plug-ins for the SRCApps;
an accounting module stored in the memory and executable on the processor, the accounting module configured to allocate tokens between SRCApps; and
an enforcement module stored in the memory and executable on the processor, the enforcement module configured to notify a plug-in that a usage violation exists, and implement an enforcement response.

2. The system of claim 1, wherein the enforcement module is stored at least in part in a portion of the memory which is unreadable by a user of the system.

3. The system of claim 1, wherein the SRCApps comprise:
a virtual machine containing one or more applications configured to run within the virtual machine; and/or
a remote desktop session with a remote computing device.

4. The system of claim 1, wherein memory further comprises the plug-ins for the SRCApps, the plug-ins comprising:
a start-up and shut-down interface in communication with the discovery and start-up module and configured to launch and/or terminate SRCApps in response to commands from the user;
an access policy interface in communication with the accounting module and configured to apply a licensing policy specified by the SRCApp vendor and request a token charge; and
an enforcement interface in communication with the enforcement module and configured to provide feedback the user and/or the administrator when a usage violation exists.

5. The system of claim 4, wherein the start-up and shut-down interface is further configured to inform the discovery and start-up module when an instance of an SRCApp is no longer active on the user terminal.

6. A computer-implemented method comprising:
under control of one or more computer systems configured with executable instructions,
receiving a command from a user terminal to instantiate a Shared Resource Computing Application (SRCApp);
creating a plug-in for the SRCApp based on a licensing policy specified by an SRCApp vendor;
determining if a token payment specified by the licensing policy is accepted;
starting an instance of the SRCApp and displaying a user interface for the SRCApp on the user terminal when the token payment is accepted; and
providing feedback indicating enforcement consequences when the token payment is not accepted.

7. The method of claim 6, wherein the user terminal comprises output devices and input devices coupled to a Shared Resource Computing (SRC) server in an SRC environment.

8. The method of claim 6, wherein the SRCApps comprise:
a virtual machine containing one or more applications configured to run within the virtual machine;
a remote desktop session with a remote computing device; and/or
a process running in a session a SRC server.

9. The method of claim 6, wherein the SRCApp comprises information describing the licensing policy, and SRCApp specific algorithms in an SRCApp store uses the information to create the plug-in such that the plug-in enforces the licensing policy.

10. The method of claim 6, wherein the token payment comprises:
permanently consuming tokens; and/or
temporarily holding the tokens while an instance of the SRCApp is active.

11. The method of claim 6, wherein tokens are added to a token storage on an SRC server by manually entering a code, loading computer-readable media into the SRC server, attaching a hardware device to the SRC server or the user terminal, or accessing an online store.

12. The method of claim 11, wherein information in the token storage is backed up on a remote computing device in communication with the SRC server via a network.

13. The method of claim 6, wherein the enforcement consequences comprise preventing the instance of the SRCApp from starting, notifying the administrator that the SRCApp cannot start, notifying the user that the SRCApp cannot start, starting an instance of the SRCApp with a warning message, and/or starting an instance of the SRCApp with limited functionality.

14. One or more computer-readable storage media storing computer-readable instructions that, when executed by a processor, configured the processor to perform acts comprising:
discovering an SRCApp when the SRCApp is initially installed on a SRC server in an SRC environment;
registering a plug-in that corresponds to the SRCApp;
analyzing licensing requirements included in the SRCApp;
determining if the licensing requirements specify charges for initial installation of the SRCApp;
when charges for initial installation of the SRCApp are specified, determining if a payment is accepted; and
when charges for initial installation of the SRCApp are not specified or when charges for initial installation of the SRCApp are specified and payment is accepted, adding an entry to the SRC server, the entry configured to launch an instance of the SRCApp when activated by an administrator or a user.

15. The one or more computer-readable storage media of claim 14, wherein the SRCApp comprises:
a virtual machine containing one or more applications configured to run within the virtual machine;
a remote desktop session with a remote computing device; and/or
a process running in a session a SRC server.

16. The one or more computer-readable storage media of claim 14, wherein the registering the plug-in comprises making an entry point in the shell of the operating system of the SRC server and assigning a global unique identifier (GUID) to the plug-in.

17. The one or more computer-readable storage media of claim 14, wherein the acts further comprise creating the plug-in such that the plug-in is configured to translate the licensing requirements into a number of tokens necessary for the SRCApp to operate.

18. The one or more computer-readable storage media of claim 14, wherein the plug-in comprises one of a component object model (COM) object, an ActiveX object, or a static extensible markup language (XML) file.

19. The one or more computer-readable storage media of claim 14, wherein the acts further comprise creating a user interface for the administrator, the user interface comprising representations of tokens within the SRC environment, the tokens comprising tokens in a shared pool, tokens restricted for use by a specific user, tokens restricted for use by the administrator, tokens limited to use during a specific time period, tokens restricted for use with specific SRCApp vendors, tokens associated with hardware devices, tokens temporarily allocated, and/or tokens permanently allocated.

20. The one or more computer-readable storage media of claim 19, wherein the acts further comprise receiving input from the administrator to the user interface and responsive to the input re-allocating tokens from a first SRCApp to a second SRCApp.

21. The one or more computer-readable storage media of claim 14, wherein when the acts further comprise:
adding the entry to the shell of the operating system of the SRC server, when the payment is accepted; and
terminating installation of the SRCApp when the payment is not accepted.

22. One or more computer-readable storage media storing computer-readable instructions that, when executed by a processor, configured the processor to perform acts comprising:
receiving a command from a user terminal to instantiate a legacy application;
registering the legacy application with a default SRCApp plug-in that provides a default licensing policy;
determining if starting an instance of the legacy application complies with the default licensing policy;
starting the instance of the legacy application and displaying a user interface for the legacy application on the user terminal when the starting complies with the default licensing policy; and
providing feedback indicating enforcement consequences when the starting does not comply with the default licensing policy.

23. The one or more computer-readable storage media of claim 22, wherein the default licensing policy comprises a number of concurrent instances of the legacy application that are permitted.

24. The one or more computer-readable storage media of claim 23, wherein the number of concurrent instances is entered by an administrator of an SRC system.
